(19) United States
(12) Patent Application Publication
(10) Pub. No.: US 2010/0076999 A1
(43) Pub. Date: Mar. 25, 2010

(54) DOCUMENT SEARCHING DEVICE AND DOCUMENT SEARCHING METHOD

(75) Inventors: Yasuhisa Okazaki, Tokushima-shi (JP); Takanori Hino, Tokushima-shi (JP); Kyoko Fujita, Tokushima-shi (JP); Mikio Moriya, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: Justsystems Corproation, Tokushima-shi, Tokushima (JP)

(21) Appl. No.: 12/442,850

(22) PCT Filed: Sep. 26, 2007
(86) PCT No.: PCT/JP2007/001043

§ 371 Date: Mar. 25, 2009

(30) Foreign Application Priority Data
Sep. 26, 2006 (JP) 2006-260107

(51) Int. Cl. G06F 17/30; G06F 7/00; G06F 12/00

(52) U.S. Cl. 707/772; 707/797; 711/147; 707/E17.039; 707/E17.008; 707/E17.012

(57) ABSTRACT

In registering a new document file in an index, the accumulated percentage of the number of registered keys A from registered keys associated with one posting data, including registered data, is computed. The posting data of a registered key associated with the number of posting data items, which is at most a threshold N, is stored in a leaf page of a balanced-plus tree constituted of the registered keys, and the posting data of a registered key associated with the number of posting data items, which is greater than the threshold N, is stored in a page of a posting-storing unit. When the accumulated number i of registered documents is a predetermined document number, the threshold N of the number of posting data items is changed to the maximum number of the posting data items that are associated with a registered key where the accumulated percentage is less than 60 percent.

### TECHNICAL FIELD

The present invention relates to a document processing technique, and particularly to a document search apparatus used for searching for a document file containing input text and a document search method applied thereto.

### BACKGROUND ART

With the development of information processing techniques and networks, necessary information can be acquired by accessing websites, databases, etc. from information terminals such as PC's (Personal Computers) and mobile phones in daily use. Meanwhile, the information compiled by use of a database system has been increasing, and this requires efficiency in acquiring necessary information from the information stored in a database. The functions of document searching, from search engines used for searching the information disclosed on websites and networks to searching systems for searching a variety of searching databases, are essential for current and proper information acquisition.

One of the examples of a document search technique based on a natural language is Ngram analysis. In Ngram analysis, a character string containing a predetermined number of characters, in other words, a “key” is cut out from a document to be searched and information indicating the position of its appearance in the document is stored in advance for respective keys. Such data is referred to as an “index”. During the search, the index is searched based on the keys contained in a search query, and a document containing the search query is specified based on, for example, the order of appearance of the keys in the search query (see, for example, patent document 1).

[Patent document 1] JP 5-274355

### Disclosure of Invention

### Technical Problem

In Ngram analysis, regardless of whether it seems logical, all the keys contained in a document are cut out so as to generate an index, and then the keys contained in a search query are checked against the index. Therefore, there is less drop-off in a search result compared to that of morphological analysis where meaning phrases are extracted. On the negative side, the data amount of an index increases rapidly as the number of documents to be searched for increases. Thus, it often requires a vast amount of time for processing since an enormous quantity of data needs to be accessed for specifying desired document information containing the search query.

In this background, a general purpose of the present invention is to provide a technique for efficiently performing the search by using Ngram analysis.

### Means for Solving the Problem

An aspect of the present invention relates to a document search apparatus. The document search apparatus comprises: a key-extraction unit operative to extract, as a registered key, a string of a predetermined number of letters from a document; an index-storing unit comprising: a posting-storing unit operative to store, for the registered key, posting data where a data set containing both identification information of a document from which the registered key is extracted and extracted position in the document is defined as one unit; and a key-storing unit having a memory area that constitutes a tree structure that associates a storage area of the posting data in the posting-storing unit with a corresponding registered key; and a search unit operative to extract a string of a predetermined number of letters from a search query as a search key and to search for a document that contains the search query by acquiring the posting data for the search key by referring to the index-storing unit, wherein at least a part of the posting data is stored in at least a part of a memory area that constitutes a node at the lowest level of the tree structure in the key-storing unit, and the search unit acquires the posting data for at least a part of search key by referring to only the key-storing unit.

The “extraction position” is a position such as the beginning position and the ending position of a registered key, and it can be in any format as long as it follows the predetermined rules shared in the document search apparatus. The posting data may include a parameter other than the identification information of a document and the data of the extraction position. Furthermore, the “memory area that constitutes a tree structure” is a memory area that corresponds to each node constituting a tree structure in an algorithm, and an actual memory area may be continuous or spread. The “search query” is a character string that is entered by a user to perform a document search. It may be either a phrase or a sentence, and there may be one or more.

Another aspect of the present invention relates to a document search method. The document search method comprises: extracting a string of a predetermined number of letters from a document as a registered key; generating, for the registered key, posting data where a data set containing both identification information of a document from which the registered key is extracted and an extracted position in the document is defined as one unit; storing, for the registered key, the posting data in a storage device; extracting a string of a predetermined number of letters from a search query as a registered key; and searching for a document that contains the search query by acquiring the posting data for the search key by referring to the storage device, wherein the memory area of the posting data in the storage device is changed in accordance with the number of posting data items for the registered key.

Optional combinations of the aforementioned constituting elements, and implementations of the invention in the form of methods, apparatuses, and systems may also be practiced as additional modes of the present invention.

### ADVANTAGEOUS EFFECTS

The present invention provides a user with an efficient loss-less search results without any drop-off.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a schematic diagram that illustrates the overview of a process by a document search apparatus according to the embodiment;

FIG. 2 is a diagram that illustrates a detailed configuration of the document search apparatus according to the embodiment;

FIG. 3 is a diagram that schematically illustrates the structure of a balanced-plus tree stored in a key storing unit in the embodiment;

FIG. 4 is a flowchart that illustrates a processing procedure of analyzing a registered document file and then registering in an index accordingly by the document search apparatus according to the embodiment;

FIG. 5 is a flowchart that illustrates the procedure of determining a memory area for storing posting data and then writing accordingly in the embodiment;

FIG. 6 is a diagram that schematically illustrates the configuration of a shared page in the embodiment; and

FIG. 7 is a schematic diagram that illustrates the configuration of a two-level-tree page in the embodiment.

### EXPLANATION OF REFERENCE

100 document search apparatus
110 user-interface processor
112 document-acquisition unit
116 search-query acquisition unit
120 registration unit
122 key-extraction unit
124 posting-generation unit
126 posting-memory-area determination unit
128 data-writing unit
130 index-storing unit
132 key-storing unit
134 posting-storing unit
137 shared page
138 private page
140 two-level-tree page
142 three-level-tree page
160 search unit
162 posting-acquisition unit
164 document-data acquisition unit
200 document database

### BEST MODE FOR CARRYING OUT THE INVENTION

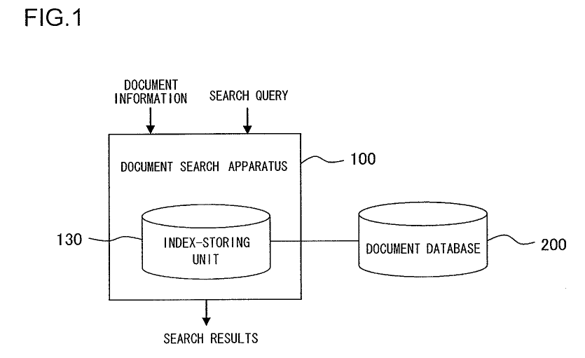

FIG. 1 is a schematic diagram that illustrates the overview of a process by a document search apparatus 100.

Upon the input of a search query by a user, the document search apparatus 100 searches for a document file that contains the search query in a document database 200. The search query is a character string that has a certain meaning, and it may be a natural-language sentence or a keyword. A document file of the document database 200 may be a structured file such as an XML (eXtensible Markup Language) document or an XHTML (eXtensible HyperText Markup Language) document, or it may be just a text file. The document database 200 may be connected to the document search apparatus 100 via a network not shown.

Prior to the search, the document search apparatus 100 performs Ngram analysis on the documents in the document database 200, generates an index, and then stores the index in an index-storing unit 130. The index-storing unit 130 can be realized in a mass storage device such as a hard disk or in a part thereof. A detailed description will be made later regarding the structure of the index. The document search apparatus 100 specifies a matching document file in the document database 200 by referring to an index based on the search query and then displays the document file on a screen as a search result. In this case, the order of displaying the result may be determined based on a score obtained by a commonly-practiced scoring technique. As described, a user of the document search apparatus 100 can find a document file containing an arbitrary search query.

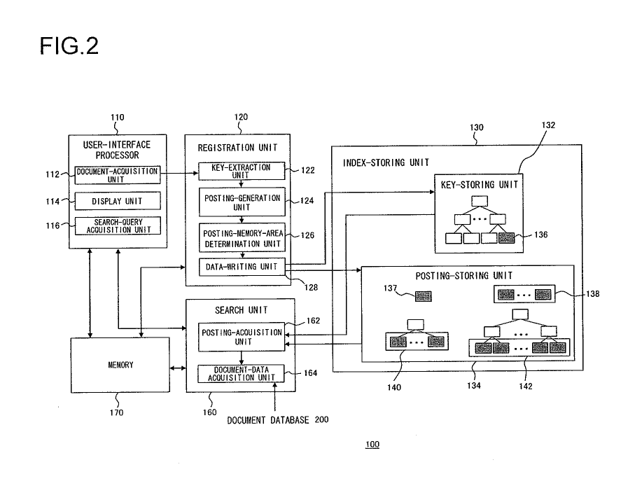

FIG. 2 shows the detailed configuration of the document search apparatus 100. The blocks shown are implemented in the hardware by any CPU of a computer, other elements, or mechanical devices, and in software by a computer program or the like. FIG. 2 depicts functional blocks implemented by the cooperation of hardware and software. Thus, a person skilled in the art should appreciate that there are many ways of accomplishing these functional blocks in various forms in accordance with the components of the combination of hardware and software.

The document search apparatus 100 is provided with a user-interface processor 110 that both receives the input from a user and outputs the result, a registration unit 120 that registers, in an index, data for a document to be searched for, a search unit 160 that performs a search based on an input search query, and an index-storing unit 130. The document search apparatus 100 is further provided with memory 170 that temporarily stores data, programs, etc., that are needed for each functional block to perform a process.

The user-interface processor 110 is in charge of processes regarding a general user interface such as for processing the input from a user and displaying information to a user. In the embodiment, an explanation is given on the premise that the user interface services of the document search apparatus 100 are provided by the user-interface processor 110. As another example, the user may operate the document search apparatus 100 via the internet. In this case, a communication unit (not shown) receives manipulation-instruction information from a user terminal and then transmits information on the results of the process performed based on the manipulation instruction.

The user-interface processor 110 is provided with a document acquisition unit 112, a display unit 114, and a search-query acquisition unit 116. In the case where a new document database 200 is constructed or where a new document file is registered to be searched, the document-acquisition unit 112 acquires the information of the document file (hereinafter referred to as a registered document file) from the input entered by a user and then provides the information to a registration unit 120. The information of the document file may be information specifying a document file stored in the document database 200 or may be information that specifying a document file stored in another place. In the latter case, the document search apparatus 100 may store, in the document database 200, the document file that is retrieved. The search-query acquisition unit 116 receives a search query entered by a user who attempts to perform a search and then provides the search query to a search unit 160.

The registration unit 120 is provided with a key-extraction unit 122, a posting-generation unit 124, a posting-memory-area determination unit 126, and a data-writing unit 128. The key-extraction unit 122 extracts a key of a predetermined number of letters, in other words, a predetermined number of grams, by reading out and then by scanning a registered document file in accordance with the information of a document file provided by the document-acquisition unit 112. For example, in the case of text “the president of the United States of America (a(katakana)/me(katakana)/ri(katakana)/ka(katakana)/ga(Chines e character)/syu(Chinese character)/koku(Chinese character)/no(hiragana)/dai(Chinese character)/tou(Chinese character)/ryou(Chinese character))”, keys are extracted as follows: “(a(katakana)/me(katakana); me(katakana)/ri(katakana);ri(katakana)/ka(katakana); . . . ; and (tou(Chinese character)/ryou(Chinese character))”. A key shown in this example contains two grams. The same extraction method applies to other languages such as English. The optimal number of grams is set in advance. The key extracted from a registered document file is referred to as “registered key” in the following description.

A posting-generation unit 124 assigns a document ID, which is uniquely set identification information, to a registered document file and generates posting data for each registered key. The posting data is information that shows the document and the position in the document where the registered key appears. The positing data is a data set that has the structure, for example, [document ID, key's beginning position, key's ending position]. If identical registered keys are extracted, the corresponding posting data items are all grouped together. For example, when key “a (katakana)/me (katakana)” is extracted four times, four posting data items are generated for the key “a (katakana)/me (katakana)”.

A posting-memory-area determination unit 126 determines the area in the index-storing unit 130 used for storing the generated posting data, and upon the determination of the area, a data-writing unit 128 writes both the posting data and the related information additionally in the index-storing unit 130. In addition to the determination of which memory area is used for storing the posting data, the posting-memory-area determination unit 126 performs a variety of processes for determining which memory area will be used. The memory area for the posting data is described in detail hereinafter.

A search unit 160 is provided with a posting-acquisition unit 162 and a document-data acquisition unit 164. The posting-acquisition unit 162 extracts a key from a search query and then acquires the posting data that corresponds to the key by referring to the index-storing unit 130. The key extracted from a search query is hereinafter referred to as the “search key”. The posting-acquisition unit 162 specifies documents that include all the search keys by the document ID contained in the posting data of each key, and it narrows down the documents, based on the key's beginning position and the key's ending position, to those documents containing the search keys that appear sequentially in the order they appear in the search query. In this manner, a document that contains a search query can be specified. The details of a basic process are described here; however, all the techniques that are generally used for a search process may be combined.

Based on the document ID of a specified document, a document-data acquisition unit 164 acquires, for example, at least a part of the document or the address of where the document is stored from the document database 200 and then stores it in a memory 170 after adjusting the display data so that a display unit 114 of a user-interface processor can display it as a search result.

The structure and memory area of an index stored in the index-storing unit 130 is described in detail in the following paragraphs. An index is the data that associates the registered key that is extracted from a registered document file with the posting data. Since a registered key is automatically extracted in accordance with the number of grams, putting the same registered keys together still leaves a wide variety of registered keys. Likewise, a registered key in the index that matches a search key is searched for during the search, and a process of specifying the posting data related to the registered key is performed. In order to efficiently detect a search key from a huge variety of registered keys, the algorithm commonly used is the algorithm of a balanced-plus tree.

The balanced-plus tree used at this time has: a root node and a branch node that determine whether to branch out to a node on a lower level in accordance with the range of the string of a registered key sorted in a predetermined order; and a leaf node, which is a terminal node, where both, possibly final registered keys narrowed down by the tree and pointers that point to the memory areas of the posting data where their respective registered keys are written. In processing a search, the same key as a search key is included in possible registered keys written in a leaf node to be reached by following nodes from a root node to a node in a lower level in accordance with a registered key; thus, a pointer to the desired posting data can be finally obtained.

In such a search process, at least two accesses are required as follows: (1) acquiring a pointer to posting data by accessing the memory area where a balanced-plus tree structure is stored; and (2) acquiring posting data by accessing the memory area where the posting data is stored. Since multiple search keys are normally extracted from one search query, repeating the same process on the search keys increases the number of accesses to a memory area. Even with the use of cache memory, an unignorable amount of time may be required, depending on the search condition.

After a series of dedicated research on shortening the time required for a search, the inventor obtained the following findings related to an index. Table 1 shows the distribution of the number of posting data items for each key in the index of a general document database. The data was obtained when registered keys containing two grams were extracted from 877,713 document files. The number of the extracted registered keys is 1,339,103.

TABLE 1

| THE NUMBER | THE NUMBER OF REGISTERED KEYS | | |
|---|---|---|---|
| OF POSTING | | ACCUMULATED | ACCUMULATED |
| DATA ITEMS | TOTAL | NUMBER | PERCENTAGE |
| 1 | 361082 | 361082 | 27.0% |
| 2 | 158249 | 519331 | 38.8% |
| 3 | 94038 | 613369 | 45.8% |
| 4 | 65485 | 678854 | 50.7% |
| 5 | 49075 | 727929 | 54.4% |
| 6-10 | 139167 | 867096 | 64.8% |
| 11-100 | 301837 | 1168933 | 87.3% |
| 101-1000 | 123738 | 1292664 | 96.5% |
| 1001-10000 | 38626 | 1331290 | 99.4% |
| 10001-100000 | 7302 | 1338592 | 99.96% |
| MORE THAN | 511 | 1339103 | 100.0% |
| 100001 | | | |

For example, in the line “3” for “the number of posting data items”, there are “94,038” registered keys associated with three posting data items as shown in the “total” column, and the accumulation value up to three posting data items, that is, the number of registered keys associated with either from one to three posting data items is “613,369”, as shown in the “accumulated number” column. The percentage of the registered keys associated with one to three posting data items among all the registered keys is “45.8 percent” as shown in the “accumulated percentage” column. According to the table, it is found that about 55 percent of all the registered keys are the registered keys associated with, at most, five posting data items. On the other hand, the registered keys each associated with at least 1001 posting data items account for only 0.6 percent of the total number of registered keys.

Therefore, as stated above, in the configuration where a pointer is acquired from a balanced-plus tree and posting data is acquired from the pointer, there is non-negligible possibility of re-accessing another memory area in order to obtain only a few posting data items. The inventor found room for the improvement in this and came to think of the following embodiment in order to effectively acquire posting data.

The above stated algorithm is basically employed in the embodiment. The index-storing unit 130 includes both a key storing unit 132 that stores a balanced-plus tree and a posting-storing unit 134 that stores each posting data item. Therefore, a pointer to the posting data, which is written in a general leaf node of the balanced-plus tree, indicates a memory area in the posting-storing unit 134. Hereinafter, a leaf node and a memory area for posting data are described by using a page as a unit, and a pointer is specified by a page number. The registered key and the posting data are hereinafter associated by the use of a balanced-plus tree. However, not only the embodiment, but also, for example, a balanced tree is within the scope of the present invention.

On the other hand, in the embodiment, a part of posting data is incorporated into the structure of a balanced-plus tree for narrowing down search keys. In other words, in addition to the combinations of registered keys and page numbers used for the posting data, the combinations of the registered keys and the posting data itself are written in the leaf page 136 of the embodiment. Therefore, the posting-memory-area determination unit 126 determines whether to store the posting data in the key storing unit 132, that is, in a leaf page 136 of the balanced-plus tree or in the posting-storing unit 134.

A posting-memory-area determination unit 126 determines the memory area for the posting data of the registered key from the number of posting data items of a respective registered key, in other words, from the sum of the posting data items of the registered key, which is newly generated from a registered document file, and the posting data item already registered in an index for the same registered key. More specifically, a threshold is set for the number of posting data items, and a registered key associated with posting data items less than or equal to the threshold number is written in the leaf page 136 of the balanced-plus tree, and a registered key associated with more than the threshold number of posting data items is written in the area in the posting-storing unit 134.

For example, if the threshold is set to “5” in a document database as shown in Table 1, the posting data items of about 55 percent of registered keys can be obtained by accessing only the key storing unit 132. The data size of about five posting data items does not burden the memory capacity of the leaf page 136, and the balanced-plus tree structure can be used without losing its balance. As a result, only the number of accesses to the index-storing unit 130 is reduced, and a quick and efficient search process is realized.

Furthermore, the posting-memory-area determination unit 126 changes the above described threshold for every predetermined number of documents that are registered based on the percentage of all registered keys. For example, for every 100,000 documents registered, the threshold is changed to the maximum number of the posting data items that the registered key is associated with, where percentage accumulated from a registered key associated with one posting data item is less than 60 percent. This arrangement is made since there is a tendency that the number of posting data items for a respective key increases as the number of registered documents increases. Fixing the threshold to be a certain posting data number under such circumstance will eventually minimize the effect of reducing the access number since the percentage of a registered key associated with posting data items greater than the threshold number increases as the number of registered documents increases.

The threshold is adjusted based on the accumulated percentage so that posting data can be always obtained from the leaf page 136 for a registered key that falls in a given percentage. According to Table 1, as the number of posting data items of each key increases, the rate of growth of the accumulated percentage decreases. In other words, the possibility of rapid increase in the number of posting data items of a registered key that falls in, for example, the accumulated percentage of 60 percent is low even when the number of registered documents increases. Thus, even when the threshold is changed as described above, the possibility is low for writing the amount of posting data, which is so numerous that both the capacity of the leaf page 136 is burdened and the balanced-plus tree structure loses its balance. As a result, the above mentioned effect can constantly be obtained regardless of the number of the registered documents.

In writing posting data in the leaf page 136, the data-writing unit 128 additionally writes the posting data in the leaf page 136 where a corresponding registered key is written. In storing posting data in the posting-storing unit 134, the data-writing unit 128 refers to the leaf page 136 where a corresponding registered key is written, acquires the page number of the posting data, which is written in association with the registered key, and additionally writes the posting data on the corresponding page in the posting-storing unit 134.

A rectangle of the smallest unit shown in the key storing unit 132 and in the posting-storing unit 134 in FIG. 2 represent a page. As described above, the key storing unit 132 and the posting-storing unit 134 store a balanced-plus tree and posting data, respectively. The data written in the leaf page 136 of balanced-plus tree includes posting data. In the figure, such a page is shown shaded. The posting data may be written in a leaf page other than the leaf page 136. The leaf page 136 is used as a representative.

It is inherent that the posting data is also stored in the posting-storing unit 134, and there are some shaded rectangles shown as pages in which the posting data is written. In the embodiment, the configuration of the page is changed by the number of posting data items of each registered key. More specifically, theses are: a shared page 137 that writes posting data of multiple registered keys in one page; a private page 138 that writes posting data of one registered key in one page or more; a two-level-tree page 140 that writes posting data of one registered key in a leaf page of two-level balanced-plus tree structure having a document ID as a key; and a three-level-tree page 142 that similarly writes posting data of one registered key in a leaf page of three-level balanced-plus tree structure. Note that the total number of each page changes in accordance with the number of posting data items. The detailed configuration of each page will follow.

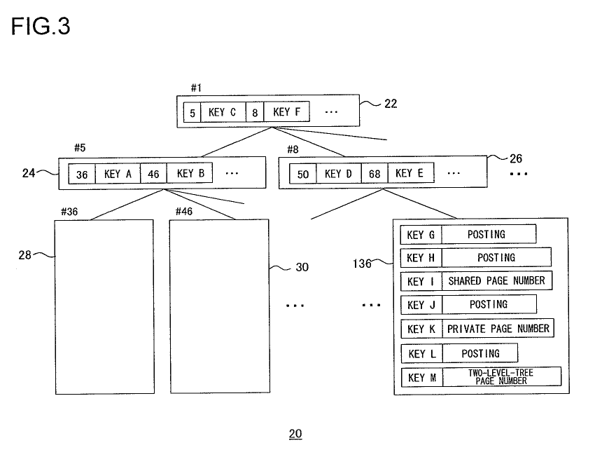

FIG. 3 schematically shows the structure of a balanced-plus tree stored in a key storing unit 132. A balanced-plus tree 20 includes a root page 22, branch pages 24 and 26, and leaf pages 28, 30, and 136. However, the page number and the depth of a level are not limited to this. The “#number” shown above the upper left corner of each page is a page number that is uniquely assigned to that page.

In the root page 22 of a page number “#1”, the data column that has the values “5”, “key C”, “8”, and “key F” is written. The keys “key C” and “key F” are character strings of specific registered keys such as “a/me” and “me/ri”. The figure shows that the registered keys from the head of the string of sorted registered keys to the registered key before “key C” are written on a page in the lower level, which is numbered page “#5”, and that the registered keys from “key C” to the registered keys before “key F” are written on a page in the lower level, which is numbered page “#8”.

In the same way, the branch page 24 which is numbered page “#5” shows that the registered keys from the head to the registered key before “key A” are written on a page numbered page “#36” and that the registered keys from “key A” to the registered keys before “key B” are written on a page numbered page “#46”. The same applies to the branch page 26 numbered page “#8”. Accordingly, the information on the posting data of the registered keys from the head to the registered key before “key A” are written on the leaf page 28 numbered page “#36”, and the information on the posting data of the registered keys from “key A” to the registered keys before “key B” are written on the leaf page 30 that is numbered page “#46”.

In the figure, the data written on the leaf pages 28, 30, etc., is illustrated as a representative example on the leaf page 136. As stated above, either posting data itself or the page number of a page in the posting-storing unit 134, where the posting data is written, is written on the leaf page 136 for each of the multiple registered keys. The figure shows that: the posting data itself written for “key G”, “key H”, “key J”, and “key L”; the page number of the shared page 137 of FIG. 2 for “key I”; the number of the head pages of the private page 138 for “key K”; and the page number of the root page of the two-level-tree page 140 for “key M”.

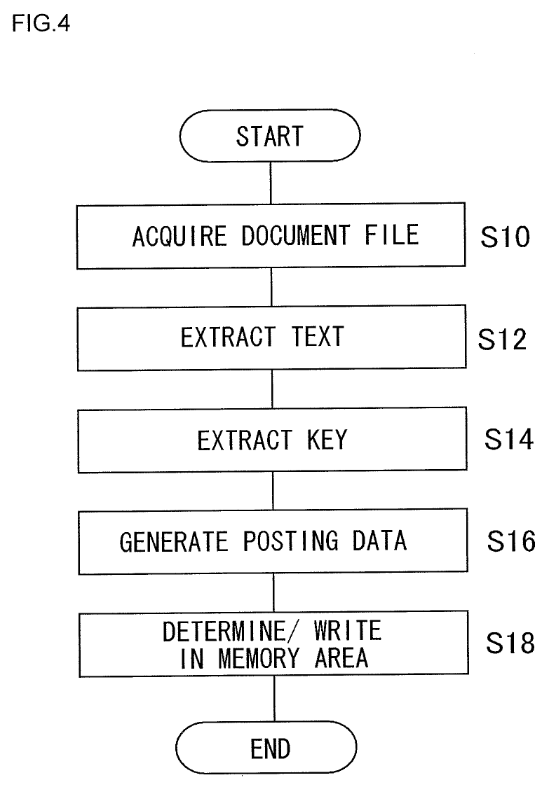

The operation of the document search apparatus 100 having the configuration described thus far is described in the following. Note that since a commonly-practiced method can be used for the procedure of the search process based on a search query performed by the search unit 160 as described, a detailed description will be made mainly regarding the method of registration in an index. FIG. 4 is a flowchart that illustrates the processing procedure of analyzing a registered document file and then registering it in an index by using the document search apparatus 100. A description is given of the registering of information of a new registered document when the index for a document file already analyzed is stored in the index-storing unit 130. However, the same distinctive procedure in the embodiment is also used for newly generating an index, and a generally-used method can be applied for the construction of a balanced-plus tree, etc.

Upon the input of the information by a user of a registered document to the document-acquisition unit 112 of the user-interface processor 110, the key-extraction unit 122 of the registration unit 120 reads out the registered document and then stores the registered document in the memory 170 (S10). The key-extraction unit 122 extracts text data from the registered document file (S12) and then extracts a registered key having a predetermined number of grams by scanning the text data (S14). The posting-generation unit 124 assigns a document ID to the registered document file and generates posting data comprising the document ID and the beginning and ending positions of the registered key for each registered key extracted by the key-extraction unit 122 (S16).

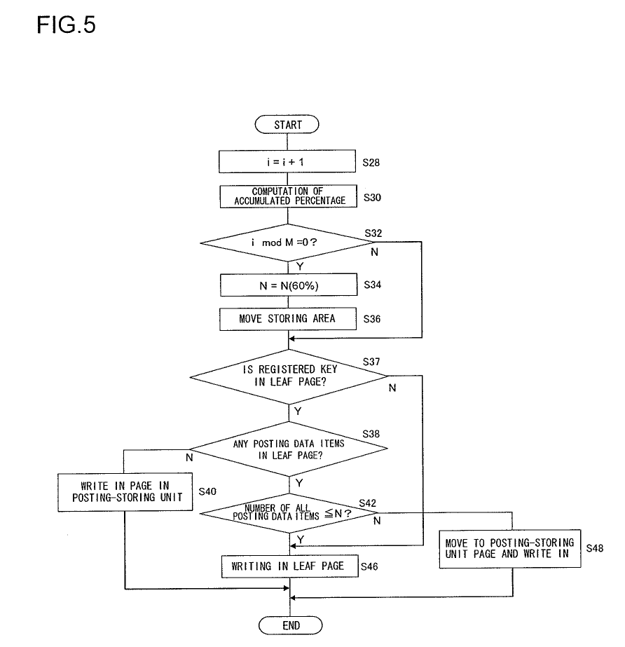

A posting-memory-area determination unit 126 then determines the storage area for the generated posting data, and the data-writing unit 128 writes the generated posting data accordingly (S18). As described earlier, the storing location is determined by the comparative size relationship between the threshold and the number of posting data items of each registered key including the posting data already registered in the index. If writing the posting data of currently extracted registered key in the leaf page 136 results in the number of the posting data items of the registered key exceeding the threshold, the posting data including the one that is already written in the leaf page 136 is moved to the posting-storing unit 134. A detailed description is now given of the processing procedure in reference to FIG. 5.

FIG. 5 is the flowchart showing that the posting-memory-area determination unit 126 determines the area for storing the posting data, and that the data-writing unit 128 then writes the posting data in S18. It is assumed that a variable I, which shows the accumulated number of document files, is reset to be “0” and that an initial entry, for example, “5” is assigned to a threshold N of the number of posting data items that can be written on the leaf page 136. After the variable i is incremented (S28), each value shown in Table 1 is calculated for the index in the case where the information of a registered document file is newly registered, and the accumulated percentage of the number of registered keys for the number of the posting data of each registered key is computed (S30). The data in Table 1 that includes the accumulated percentage is temporarily stored in the memory 170, etc., and then stored in a hard disk, etc., which constitutes the index-storing unit 130 when the process of the document search apparatus 100 is terminated. In newly registering a document, each value should be updated by the calculation in reference to the previous data stored in that manner.

The variable i is then divided by a predetermined number of documents M, for example, 100,000, so as to obtain the remainder. If the remainder is not 0, in other words, if the registered document file is not a document item that accounts for multiples of 100,000 (N in S32), the balanced-plus tree is traversed for each extracted registered key so as to first check whether the registered key is written on the leaf page 136 (S37). If the registered key is not registered in advance, the registered key is not written in the leaf page 136 (N in S37). Thus, the registered key and the posting data are written on the leaf page 136 (S46).

If the registered key is already written (Y in S37), the leaf page 136 is further checked to see whether the posting data of registered key is written (S38). If the posting data is not written but the page number is written (N in S38), the posting data is additionally written on the page with the aforementioned page number contained in the posting-storing unit 134 (S40).

If the posting data is written in the leaf page 136 (Y in S38), the number of posting data items after the addition of the new posting data is checked to see whether the number of posting data items exceeds the threshold N (S42). If the number of posting data items does not exceed the threshold N (Y in S42), the posting data is additionally written on the leaf page 136 (S46). If the number of the posting data items exceeds the threshold N (N in S42), after the posting data of the registered key already written is moved to, for example, the shared page 137 prepared in the posting-storing unit 137, the new posting data is additionally written on the same page (S48). The page number of the destination pages is written on the leaf page 136 of the source in association with the key at this time in advance.

If the registered document file accounts for the multiples of a predetermined number of documents M (Y in S32), the threshold N is changed based on the accumulated percentage that is computed in S30 (S34). The expression N (60 percent) represents the maximum number of the posting data items of the registered key where the accumulated percentage does not exceed 60 percent. Note that 60 percent is an example and that the optimal value may be determined by experiments, etc., in consideration of the type of database, the processing performance of the document search apparatus 100, etc. If there is posting data that needs to be written in the leaf page 136 as a result of the change in the threshold N, the posting data is moved from the posting-storing unit 134 to the leaf page 136 (S36). The process that follows is as mentioned above.

Through the above procedure, the aspect can be achieved where the posting data is allocated to the leaf page 136 and the posting-storing unit 134 while changing the threshold of the number of posting data items as the number of registered documents increases.

A detailed description will be made regarding the configuration of the page where the posting data stored in the posting-storing unit 134 is written. As described above, by writing the posting data in any one of: the shared page 137; the private page 138; the two-level-tree page 140; and the three-level-tree page 142 in accordance with the number of posting data items for the respective registered key, the memory area is efficiently used and the processing efficiency of the search is also improved in the embodiment. Note that the tree page may be in four levels or more if needed.

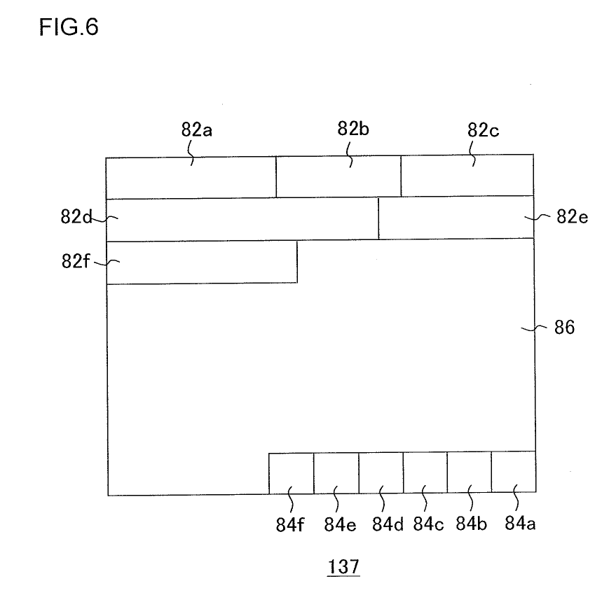

FIG. 6 schematically shows the configuration of the shared page 137. The posting data of multiple keys is written with as few spaces as possible in the shared page 137. When the number of posting data items exceeds the threshold, the posting data of a registered key in the leaf page 136 is moved to the shared page 137. Taking the data capacity of one page, which is 8 KB, into consideration, if the maximum number of the posting data items for each registered key is around 500, the posting data can be written in the shared page 137.

The shared page 137 includes posting data areas 82a-82f, pointer areas 84a-84f, and a free space 86. The figure shows that posting data items of six registered keys are each written in six posting data areas 82a-82f in a series, respectively. Since the number of posting data items varies for every registered key, the length of the posting data also varies. An offset value of each of the posting areas 82a-82f from the beginning of the page is written in each of the pointer areas 84a-84f, respectively. If a new posting data item is added to any of the posting areas 82a-82f, the offset values for the following posting data areas are updated.

In moving the posting data from the leaf page 136, the shared page 137 in which the posting data will be stored and that will have a higher filling rate is searched for. Therefore, the capacity of the free space 86 is managed. For example, a register of two bits (not shown) is prepared, and data that shows four levels: less than 25 percent, 25 percent or more but less than 50 percent, 50 percent or more but less than 75 percent, 75 percent or more and 100 percent or less for the capacity of the free space 86 is stored. The value of the register is stored on a hard disk, etc., at the end of the processing of the document search apparatus 100 and is referred to at the next registering process.

According to the Table 1, the registered keys associated with 500 or less posting data items account for about 90 percent of the entire registered keys. Therefore, in addition to storing the posting data in the leaf page 136, by storing the posting data item in the shared page 137 without any spaces, the capacity required can be dramatically reduced, compared to that of the conventional method where one page is prepared for each key. Also, area management such as to keep a new free page can be skipped, and thus the efficiency during the registration process is improved.

If the posting data of the registered key that is written in the shared page 137 is increased too much to be included in one page, the posting data is moved to the private page 138. The private page is constituted of one or more pages that one registered key privately uses, and the pages are simply linked according to the number of posting data items. For example, it is assumed that up to eight pages can be linked. In this case, about 500-4000 posting data items can be stored for one registered key.

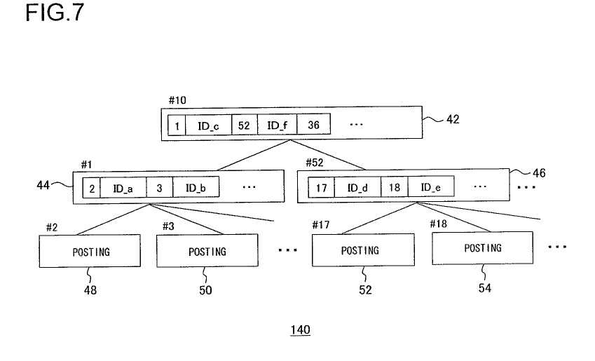

When the posting data amount exceeds the capacity of the private page 138 having the maximum linked pages, the two-level-tree page 140 is constructed where the posting data is stored in the leaf page. FIG. 7 schematically shows the configuration of the two-level-tree page 140. The two-level-tree page 140 basically has the same balanced-plus tree configuration as that shown in FIG. 3. The branching of the page is performed according to a document ID instead of a registered key.

As previously stated, when performing a search process, the search unit 160 extracts a search key from an input search query and then detects a document that both contains all the search keys and appears in a series in the order shown in the search query. When “key a” and “key b” are extracted from the search query as search keys, the posting data of “key a” is acquired first, and its document ID is stored in the memory 170. Among the posting data of “key b”, the acquired posting data that has the document ID stored in the memory 170 is thus the posting data of a document that contains both “key a” and “key b”.

In the case of the data structure where the posting data is simply arranged in sequence, if “key b” has an enormous quantity of posting data that exceeds 4,000 or the like, all the posting data must be checked from the beginning against the document ID of the document that contains “key a”. The greater the number of search keys, the more the process needs to be repeated, resulting in the increase of the number of accesses to the posting-storing unit 134.

Therefore, in acquiring such posting data of “key b” that has the posting data of more than 4,000, by traversing a balanced-plus tree structure as shown in FIG. 7 using the document ID of the document containing “key a”, only the posting data of the document containing “key a” is checked in the embodiment. In FIG. 7, the two-level-tree page 140 includes a root page 42, branch pages 44 and 46, and leaf pages 48, 50, 52, and 54. As in FIG. 3, the root page 42 shows, in the document ID string where document ID's of all the posting data items for a given registered key are sorted, that the information of the posting data having document ID's from the head of the string to before “ID_c” is written on page “#1” and the information of the posting data having document ID's from “ID_c” to before “ID_f” is written on page “#52”.

Similarly, the branch page 44 of page “#1” shows that the posting data having document ID's from the head of the string to before “ID_a” is written on page “#2” and the posting data having document ID's from “ID_a” to before “ID_b” is written on page “#3”. The same applies to the branch page 46 that is numbered page “#52”. In the leaf page 48 of page “#2”, the leaf page 50 of page “#3”, the leaf page 52 of page “#17”, and the leaf page 54 of page “#18”, the posting data which corresponds to each document ID is written, respectively.

Such a configuration allows for the reduction of the number of accesses to the posting-storing unit 134 since the posting data items for documents that do not contain “key a” can be skipped in the example above. The process required for checking the posting can be also skipped, resulting in the notable reduction of time required for the search process.

In the two-level-tree page 140, up to 8 MB, that is, about 500 thousand posting data items can be stored. If the posting data of a registered key increases too much to be included in the two-level-tree page 140, a three-level-tree page 142 that stores the posting data in the leaf page is constructed. The three-level-tree page 142 is the same as the two-level-tree page 140 except that the branch pages are two-leveled. In the three-level-tree page 142, up to 8 GB, that is, about 500 million posting data items can be stored.

According to the embodiment stated above, depending on the number of posting data items of each registered key, the storage area for the posting data is changed from the leaf page 136 of a balanced-plus tree structure in the key storing unit 132, to the shared page 137 in the posting-storing unit 134, to the private page 138, to the two-level-tree page 140, and to the three-level-tree page 142. If the number of posting data items increases in accordance with the number of registered documents, the data is moved in the order described above. This allows for lean management of the memory area that constantly matches the data size of posting data item.

Furthermore, by storing the posting data item of a size that does not affect the balance of the balanced-plus tree structure in the leaf page 136 of the balanced-plus tree, re-accessing to the posting-storing unit 134 during the search process is no longer needed, and the number of accesses decreases as a whole, resulting in speeding up the search process. In a generally used document database, since there are about several numbers of posting data items for most registered keys, notable effects can be obtained.

If the size of the posting data is less than the size of one page, the posting data of multiple registered keys is stored in the shared page 137 without any spaces in between. With this, an extra memory area does not need to be kept. Thus, the memory area is saved. Also, the process of keeping a new page, for example, when the posting data is moved from the leaf page 136 is more likely to be skipped. Furthermore, for a registered key that is associated with an enormous quantity of posting data of over 4000, a balanced-plus tree is constructed and the posting data is stored in a leaf page. Traversing the balanced-plus tree by using a document ID allows unnecessary posting data to be skipped. Accordingly, not only the number of the accesses to the posting-storing unit 134 can be reduced but also the time required for checking the posting data can be shortened.

In the embodiment, according to the increase in the number of registered documents, the threshold for the number of posting data items to be stored in the leaf page 136 of a balanced-plus tree in the key storing unit 132 is adjusted. This allows certain percentage of the posting data of the registered key to be stored constantly in the leaf page 136 even when the number of posting data items increases as a whole due to the increase in the number of registered documents. In a generally used document database, since the number of posting data items for each registered key does not increase much even when the number of documents increases, a small change in the threshold does not affect the balance of the balanced-plus tree. As a result, since no adverse effect is caused, the embodiment does not become a mere facade.

Described above is an explanation based on the embodiments of the present invention. These embodiments are intended to be illustrative only, and it will be obvious to those skilled in the art that various modifications to constituting elements and processes could be developed and that such modifications are also within the scope of the present invention.

For example, in the above stated embodiment, the posting data is moved in the order of a shared page, a private page, a two-level-tree page, and a three-level-tree page when the capacity of the page where the posting data is stored is reached. On the other hand, the size of the posting data may be predicted in advance so that a page can be prepared accordingly. For example, a dictionary, which associates registered keys that often appear in a generally-used document database with the data size of posting data items for each range of the number of registered documents, may be prepared in advance, and a page predicted to be necessary may be prepared for each registered key by referring to the dictionary every time a predetermined number of documents is registered.

Also, by studying the speed the posting data increases in relation to the increase of the registered document, the page for storing may be periodically reviewed. In these cases, the same effects as those obtained in the embodiment can also be obtained. Since the schedule for performing a process of moving the posting data can be known, the total process efficiency can be increased, for example, when another process is performed in parallel.

In the embodiment, the posting data to be stored in the leaf page of a balanced-plus tree in the key-storing unit 132 is specified as belonging as the registered key associated with the posting data less than or equal to a given threshold. On the other hand, the determination may be performed by using the registered key itself without setting a threshold. Also in this case, a dictionary, which associates a registered key with the best destination for each range of the number of registered documents, may be prepared in advance, and by referring to the dictionary, the leaf page or any other pages may be determined as the destination for storing.

### INDUSTRIAL APPLICABILITY

As described above, the subject invention can be applied to a search apparatus, a computer, etc., that can perform a document search based on a natural language.

1. A document search apparatus comprising:
a key-extraction unit operative to extract, as a registered key, a string of a predetermined number of letters from a document;
an index-storing unit comprising: a posting-storing unit operative to store, for the registered key, posting data where a data set containing both identification information of a document from which the registered key is extracted and extracted position in the document is defined as one unit; and a key-storing unit having a memory area that constitutes a tree structure that associates a storage area of the posting data in the posting-storing unit with a corresponding registered key; and
a search unit operative to extract a string of a predetermined number of letters from a search query as a search key and to search for a document that contains the search query by acquiring the posting data for the search key by referring to the index-storing unit,
wherein at least a part of the posting data is stored in at least a part of a memory area that constitutes a node at the lowest level of the tree structure in the key-storing unit, and the search unit acquires the posting data for at least a part of search key by referring to only the key-storing unit.

2. The document search apparatus according to claim 1, wherein the posting data stored in a memory area that constitutes a node at the lowest level of the tree structure in the key-storing unit is the posting data of the registered key where the number of posting data items is at most a given threshold.

3. The document search apparatus according to claim 2 further comprising:
a posting-generation unit operative, when the key-extraction unit extracts the registered key from a new document, to generate the posting data for the registered key;
a posting-memory-area determination unit operative to determine, for the registered key, a destination used for the storage of the posting data generated by the posting-generation unit to be either a memory area that constitutes a node on the lowest level of the tree structure or the posting-storing unit,
wherein when adding new posting data to the posting data stored in a memory area constituting a node on the lowest level of the tree structure results in the number of posting data items of the registered key exceeding the threshold, the posting-memory-area determination unit moves all the posting data of the registered key to the posting-storing unit to be stored.

4. The document search apparatus according to claim 3, wherein the posting-memory-area determination unit adjusts the threshold so that the posting data of the registered key that accounts for a predetermined percentage of all registered keys stored in the index-storing unit is stored in a memory area that constitutes a node on the lowest level of the tree structure.

5. The document search apparatus according to claim 4, wherein the posting-memory-area determination unit adjusts the threshold every time the number of documents from which the key-extraction unit extracts a registered key reaches a predetermined number, and, when there is a registered key where the number of posting data items stored in a memory area constituting a node on the lowest level of the tree structure exceeds a threshold as a result of the adjustment, all the posting data of the registered key is moved to the posting-storing unit to be stored.

6. The document search apparatus according to claim 3, wherein
the posting-storing unit contains at least any one of: a shared memory area where memory areas having variable lengths that are each provided to each of a plurality of the registered keys coexists with another; a private memory area that has a predetermined unit of memory area of which each registered key has sole possession; and a tree memory area constructed for each registered key, which has a tree memory area that constitutes a tree structure associating identification information of the document and the posting data, and
the posting-memory-area determination unit determines, depending on the number of posting data items for the registered key, a destination used for the storage of the posting data to be stored in the posting-storing unit to be any one of: the shared memory area; the private memory area; and the tree memory area.

7. The document search apparatus according to claim 1 wherein the tree structure of a memory area in the key-storing unit has a balanced-plus tree structure where a registered key is used as a key.

8. The document search apparatus according to claim 6 wherein the tree structure of the tree memory area in the posting-storing unit has a balanced-plus tree structure where the identification information of the document is used as a key.

9. A document search method comprising:
extracting a string of a predetermined number of letters from a document as a registered key;
generating, for the registered key, posting data where a data set containing both identification information of a document from which the registered key is extracted and an extracted position in the document is defined as one unit;
storing, for the registered key, the posting data in a storage device;
extracting a string of a predetermined number of letters from a search query as a registered key; and
searching for a document that contains the search query by acquiring the posting data for the search key by referring to the storage device,
wherein the memory area of the posting data in the storage device is changed in accordance with the number of posting data items for the registered key.

10. The document search method according to claim 9 further comprising:
storing a tree structure that associates the registered key and the storage area of the posting data in the storage device, wherein,
in storing the posting data in the storage device, at least a part of the posting data is stored in at least a part of a memory area that constitutes a node on the lowest level of the tree structure.

11. The document search method according to claim 9 further comprising: moving the posting data at least a part of the registered keys in accordance with the latest value of the number of the posting data items for each registered key.

12. A computer program product comprising:
a module that extracts all strings of a predetermined number of letters from a document as a registered key;
a module that generates, for the registered key, posting data where both the identification information of the document from which the registered key is extracted and the extraction position in the document are defined as one unit;
a module that stores the posting data in a storage device for the registered key;
a module that extracts a string of a predetermined number of letters from a search query as a registered key; and
a module that searches for a document that contains the search query by acquiring the posting data for the search key by referring to the storage device,
wherein the module that stores the posting data in the storage device changes the memory area of the posting data in the storage device in accordance with the number of posting data items for the registered key.
